(19) United States
(12) Patent Application Publication
(10) Pub. No.: US 2007/0017980 A1
(43) Pub. Date: Jan. 25, 2007

(54) Method and system of purchasing a transportation ticket by using a transaction card

(75) Inventors: Ronald Lee, Sindian City (TW); Gino Li, Sindian City (TW)

Correspondence Address: BACON & THOMAS, PLLC, 625 SLATERS LANE, FOURTH FLOOR, ALEXANDRIA, VA, 22314, US

(73) Assignees: Gino LI, Sindian City (TW); Ronald Lee, Sindian City (TW)

(21) Appl. No.: 11/311,314

(22) Filed: Dec. 20, 2005

(30) Foreign Application Priority Data
Jul. 21, 2005 (TW) 094124666

(51) Int. Cl. G06K 5/00; G07B 15/02; G07B 15/00

(52) U.S. Cl. 235/382; 235/384; 705/13

(57) ABSTRACT

The invention discloses a method and system for purchasing a transaction ticket by using a transaction card. A transaction card device transmits a ticket purchasing request including transportation information and transaction card information to an acquiring bank server. The acquiring bank server generates a ticket ordering request according to the transportation information so as to process a reservation procedure with a ticketing system, and then transmits a card authorization request generated according to the transaction card information of the ticket purchasing request and the price of a ticket ordering response to the issuing bank server. After the issuing bank server checks corresponding transaction card information and approves the request, a card authorization response is returned to the acquiring bank server. Then, the acquiring bank server generates a ticket purchase response to the transaction card device for outputting transportation ticket information and a bill.

### BACKGROUND OF THE INVENTION

1. Field of the Invention

The present invention relates to a method and system of purchasing a transportation ticket, and more particularly, to a method and system of purchasing a transportation ticket by using a transaction card.

2. Description of Related Art

With the rapid growth of societies, it has become popular for people to take a short-term, long-term, international business/tourism journeys etc. by airplanes, boats, trains, or other kinds of transportation. However, the matter of how to make a rapid reservation and purchasing for getting right information for taking the proper transportation to the destination in the right place at the right time has become a major problem for both the travel agents and passengers. Conventionally, the passenger has to go to the transportation company or the travel agency counter to make reservations and purchase transportation tickets, such as flight tickets, boat tickets or railway tickets. Further, if the passenger has an emergency ticket ordering request, or suddenly wants to change the flight, he/she might need to keep monitoring the transportation ticket and flight information with the transportation company or travel agent by phone. As a result, the above-mentioned factors might cause great inconvenience to the passenger. Therefore, it is desirable to provide a more convenient ticketing service to allow the passenger to purchase transportation tickets so as to mitigate and/or obviate the aforementioned problems.

### SUMMARY OF THE INVENTION

The present invention relates to a method and system of purchasing a transportation ticket by using a transaction card. The transaction card can be used in a transaction card device so as to purchase the transportation ticket from a transportation company. The transaction card device is connected to an acquiring bank server, and the acquiring bank server is connected to a plurality of issuing bank servers and a ticketing system. The above method comprises the following steps: (A) inputting transportation information of a desired transportation ticket to the transaction card device and using the transaction card via the transaction card device, so as to generate a ticket purchasing request including the transportation information and transaction card information, and to transmit the ticket purchasing request to the acquiring bank server; (B) the acquiring bank server generating a ticket ordering request according to the transportation information of the ticket purchasing request, and transmitting the ticket ordering request to the ticketing system; (C) the ticketing system processing a reservation procedure for the transportation ticket according to the ticket ordering request, and returning a ticket ordering response including the transportation ticket information and its price to the acquiring bank server; (D) the acquiring bank server generating a card authorization request according to the transaction card information of the ticket purchasing request and the price of the ticket ordering response, and transmitting the card authorization request to the issuing bank server of the transaction card; (E) the issuing bank server receiving the card authorization request, and returning a card authorization response to the acquiring bank server after checking corresponding transaction card information and approving the card authorization request; (F) after receiving the card authorization response, the acquiring bank server generating a ticket purchasing response according to the card authorization response, the transportation information and the price, and returning the ticket purchasing response to the transaction card device; and (G) the transaction card device outputting the transportation ticket information and a bill so as to complete the reservation procedure according to the ticket purchasing response.

Further, in above step (D), if the issuing bank of the transaction card is a foreign bank, the acquiring bank server transmits the ticket purchasing request to the issuing bank server via an international transaction card organization server. Likewise, in above step (E), if the issuing bank of the transaction card is a foreign bank, the issuing bank server returns the card authorization response to the acquiring bank server via the international transaction card organization server. In above step (F), the acquiring bank server confirms the reservation procedure of the transportation ticket with the ticketing system after receiving the card authorization response.

Therefore, the above method and system provide a ticket purchasing service to consumers for purchasing transportation tickets from transportation companies by using transaction cards via the transaction card device provided by the acquiring bank.

The abovementioned transportation information includes a transportation company code, an origin code, a destination code, a departure date and time, a return date and time, and passenger personal information.

The abovementioned transaction card information includes the personal credit reference and personal information of a card holder.

The abovementioned transportation company can be an airline, a boat company, a railway or a bus company.

The above transaction card can be a charge card or a credit card.

The above transportation ticket can be a flight ticket, a boat ticket, a train ticket or a bus ticket.

The above transaction card device can be a card machine, a computer terminal, and so on.

Other objects, advantages, and novel features of the invention will become more apparent from the following detailed description when taken in conjunction with the accompanying drawings.

### BRIEF DESCRIPTION OF THE DRAWINGS

FIG. 1 illustrates a system structure of purchasing a transportation ticket by using a transaction card of one preferred embodiment according to the present invention;

FIG. 2 depicts a procedure of purchasing a transportation ticket by using a transaction card of the preferred embodiment according to the present invention; and

FIG. 3 illustrates a perspective view of a transaction card device of the preferred embodiment according to the present invention.

### DETAILED DESCRIPTION OF THE PREFERRED EMBODIMENT

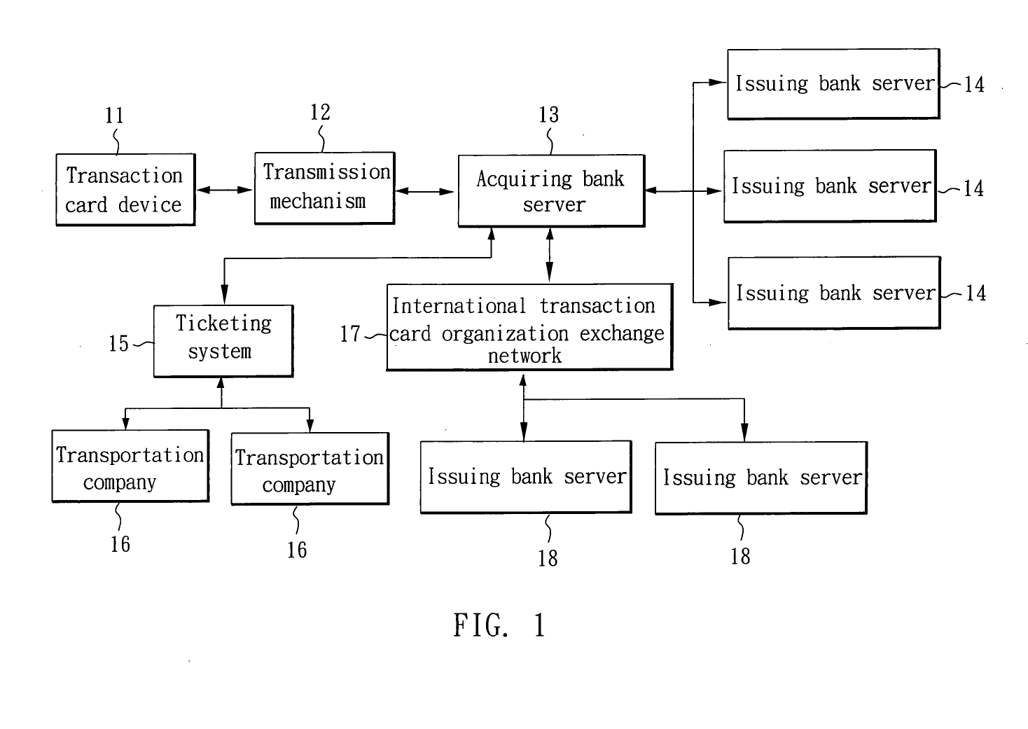

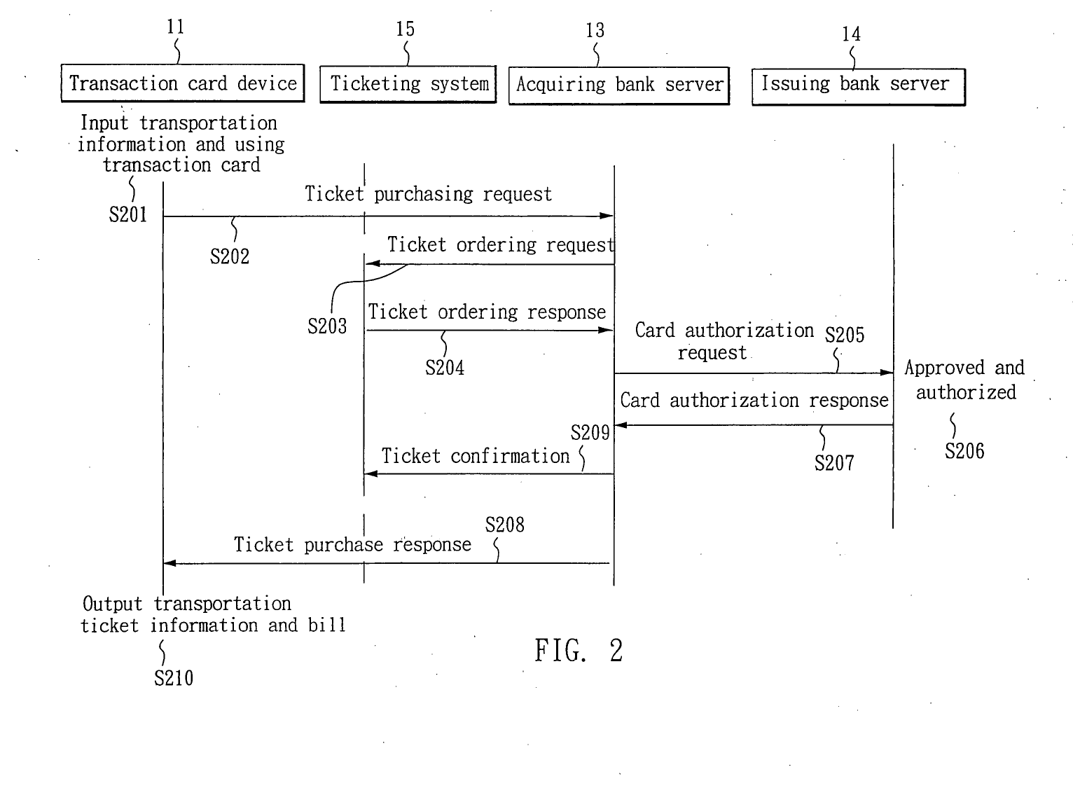

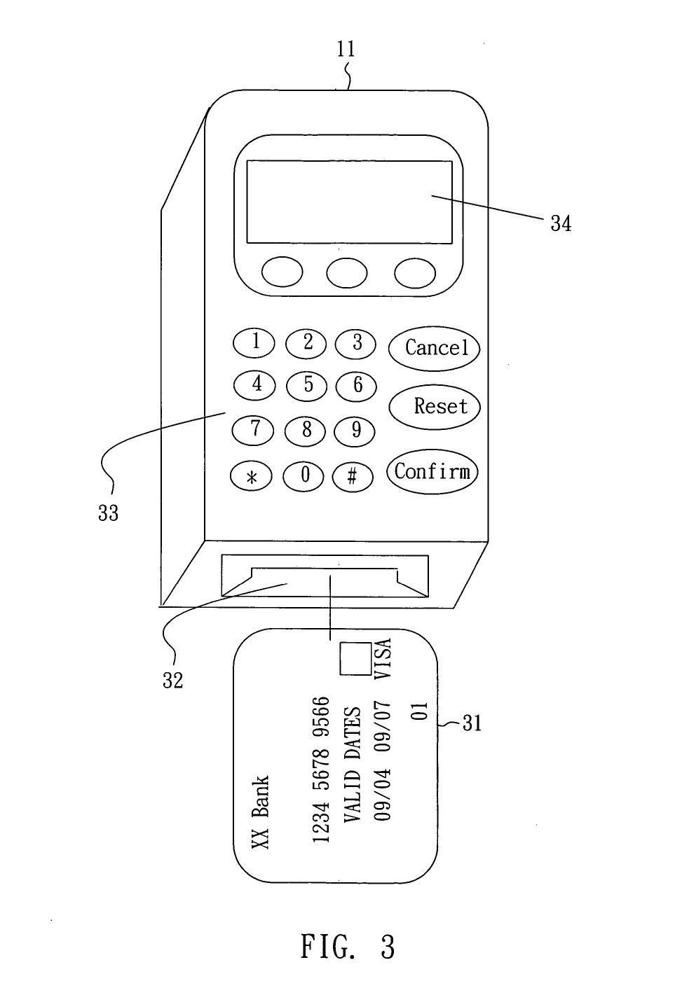

Please refer to FIGS. 1 and 2. FIG. 1 illustrates a system structure of purchasing a transportation ticket by using a transaction card, and FIG. 2 depicts a procedure of purchasing a transportation ticket by using a transaction card of the preferred embodiment according to the present invention. This invention provides a service for a user to purchase a transportation ticket by using a transaction card 31 (shown in FIG. 3) via a transaction card device 11. In this embodiment, the transportation ticket is a flight ticket, the transaction card 31 can be a credit card or a charge card, and the transaction card device 11 can be a transaction card reader or a computer device. As shown in FIG. 3, the transaction card device 11 is a transaction card reader in this embodiment. Like general transaction card readers, the transaction card device 11 of this embodiment has a card slot 32 for insertion of the transaction cards and reading its information, a keyboard set 33 for inputting information, and a display 34 for displaying information. When processing a typical card transaction, the transaction card device 11 acts exactly the same as general transaction card readers; while processing a ticket reservation procedure, a ticket purchasing mode is entered by inputting a specific key, such as ‘#’ or ‘*’, via the keyboard set 33 before using the transaction card 31. Further, if the transaction card device 11 is a computer device, the aforesaid card transaction can be processed by using a card reader equipped in the computer device, or by directly inputting the information of the transaction card 31.

Please refer to FIG. 1 again. The abovementioned transaction card device 11 can be regarded as an acquiring bank server set in a store or point of sale, thereby the consumer can input flight information of a desired flight ticket into the transaction card device 11. In this embodiment, the transaction card device 11 is a transaction card reader for the user to purchase a transportation ticket from a transportation company 16 by using the transaction card. The transportation company 16 can be an airline, a boat company, a railway, a bus company or the like.

Please also refer to FIG. 2. When starting to purchase the transportation ticket, at first the specific key of the keyboard set 33 is pressed for entering the ticket purchasing mode. Then, the flight information can be inputted into the transaction card device 11, and the transaction card is used for inputting the transaction card information (S201). The transaction card device 11 generates a ticket purchasing request including flight information and transaction card information according to the previously inputted information, and transmits the ticket purchasing request to the acquiring bank server 13 via a transmission mechanism 12 (S202). Please note that the transmission mechanism 12 is, but not limited to, a wired connection, wireless connection or networked connection, and the acquiring bank server 13 is connected to an issuing bank server 14 and a ticketing system 15. Furthermore, the aforesaid flight information can include a transportation company code, an origin code, a destination code, a departure date and time, a return date and time, and passenger personal information. Moreover, the transaction card information comprises personal credit reference and personal information of a card holder.

When the acquiring bank server 13 receives the ticket purchasing request, it generates a ticket ordering request according to the flight information of the ticket purchasing request, and transmits the ticket ordering request to the ticketing system 15 (S203). The ticketing system 15 then processes a reservation procedure for the transportation ticket from a designated transportation company 16. Once the reservation procedure is confirmed, the ticketing system 15 generates a ticket ordering response including the transportation ticket information and its price, and returns the ticket ordering response to the acquiring bank server 13 (S204). Next, the acquiring bank server 13 generates a card authorization request according to the transaction card information of the ticket purchasing request and the price of the ticket ordering response, and transmits the card authorization request to the issuing bank server 14 of the transaction card (S205). If the issuing bank of the transaction card is a foreign bank, the acquiring bank server 13 can transmit the card authorization request to the issuing bank server 18 via an international transaction card organization exchange network 17.

When the issuing bank server 14 receives the card authorization request and approves it after checking corresponding transaction card information (S206), the issuing bank server 14 then returns a card authorization response to the acquiring bank server 13 (S207). After the inquiring bank server 13 receives the card authorization response, it generates a ticket purchasing response according to the card authorization response, the flight information and price, and returns the ticket purchasing response to the transaction card device 11 (S208). Meanwhile, the acquiring bank server 13 confirms the reservation procedure of the transportation ticket with the ticketing system 15 (S209). Finally, the transaction card device 11 outputs transportation ticket information and a bill so as to complete the reservation procedure according to the ticket purchasing response (S210). That is, the transaction card device 11 prints out the transportation ticket information or an electronic transportation ticket, and the bill of the transaction card, so that the user can sign the bill for completing the transaction. As a result, the user can obtain the boarding pass by showing the electronic transportation ticket to the check-in counter when preparing to board the airplane, boat, train or bus.

According to the above description, the present invention illustrates the transaction card that almost everyone has at least one in hand to purchase transportation tickets. As a result, all the consumer needs to do is to find out a transaction card device 11 of a store and use the transaction card when purchasing a transportation ticket. By the message transmission mechanism of the transaction card network, the transaction card device 11 processes a ticket purchasing procedure from the ticketing system 15 of transportation companies via the acquiring bank server 13, so as to provide a fast and convenient ticket purchasing method and system.

Although the present invention has been explained in relation to its preferred embodiment, it is to be understood that many other possible modifications and variations can be made without departing from the spirit and scope of the invention as hereinafter claimed.

What is claimed is:

1. A method of purchasing a transportation ticket by using a transaction card, the transaction card being used via a transaction card device so as to purchase the transportation ticket from a transportation company, the transaction card device being connected to an acquiring bank server, the acquiring bank server being connected to a plurality of issuing bank servers and a ticketing system, the method comprising the steps of:
(A) inputting transportation information of a desired transportation ticket to the transaction card device and using the transaction card via the transaction card device, so as to generate a ticket purchasing request including the transportation information and transaction card information, and to transmit the ticket purchasing request to the acquiring bank server;
(B) the acquiring bank server generating a ticket ordering request according to the transportation information of the ticket purchasing request, and transmitting the ticket ordering request to the ticketing system;
(C) the ticketing system processing a reservation procedure for the transportation ticket according to the ticket ordering request, and returning a ticket ordering response including the transportation ticket information and its price to the acquiring bank server;
(D) the acquiring bank server generating a card authorization request according to the transaction card information of the ticket purchasing request and the price of the ticket ordering response, and transmitting the card authorization request to the issuing bank server of the transaction card;
(E) the issuing bank server receiving the card authorization request, and returning a card authorization response to the acquiring bank server after checking corresponding transaction card information and approving the card authorization request;
(F) after receiving the card authorization response, the acquiring bank server generating a ticket purchasing response according to the card authorization response, the transportation information and the price, and returning the ticket purchasing response to the transaction card device; and
(G) the transaction card device outputting the transportation ticket information and a bill so as to complete the reservation procedure according to the ticket purchasing response.

2. The method as claimed in claim 1, wherein in step (D), the acquiring bank server transmits the card authorization request to the issuing bank server via an exchange network of an international transaction card organization.

3. The method as claimed in claim 1, wherein in step (F), the acquiring bank server confirms the reservation procedure of the transportation ticket with the ticketing system after receiving the card authorization response.

4. The method as claimed in claim 1, wherein the transportation company is an airline, a boat company, a railway or a bus company.

5. The method as claimed in claim 1, wherein the transportation information includes a transportation company code, an origin code, a destination code, a departure date and time, a return date and time, and passenger personal information.

6. The method as claimed in claim 1, wherein the transaction card is a charge card or a credit card.

7. The method as claimed in claim 1, wherein the transaction card information includes personal credit reference and personal information of a card holder.

8. The method as claimed in claim 1, wherein the transaction card device is a card machine or a computer terminal.

9. The method as claimed in claim 1, wherein the transportation ticket is a flight ticket, a boat ticket, a train ticket or a bus ticket.

10. A system of purchasing a transportation ticket by using a transaction card, comprising:
a transaction card device for inputting transportation information of a desired transportation ticket and using a transaction card, so as to generate a ticket purchasing request including the transportation information and transaction card information;
an acquiring bank server connected to a plurality of issuing bank servers, for receiving the ticket purchasing request and generating a ticket ordering request according to the transportation information of the ticket purchasing request; and
a ticketing system connected to the acquiring bank server, for receiving the ticket ordering request, processing a reservation procedure for the transportation ticket, and returning a ticket ordering response including the transportation ticket information and its price to the acquiring bank server, thereby the acquiring bank server generating a card authorization request according to the transaction card information of the ticket purchasing request and the price of the ticket ordering response, transmitting the card authorization request to the issuing bank server of the transaction card for getting a card authorization response from the issuing bank server, generating a ticket purchasing response according to the card authorization response, the transportation information and the price, and returning the ticket purchasing response to the transaction card device for outputting the transaction card information and a bill so as to complete the reservation procedure.

11. The system as claimed in claim 10, wherein the ticket purchasing request of the transportation information and transaction card information is transmitted to the acquiring bank server via a transmission mechanism, and the mechanism is a wired connection, a wireless connection or a networked connection.

12. The system as claimed in claim 10, wherein the acquiring bank server is connected to the plurality of issuing bank servers via an exchange network of an international transaction card organization.

13. The system as claimed in claim 10, wherein the ticketing system is connected to a plurality transportation companies including an airline, a boat company, a railway or a bus company.

14. The system as claimed in claim 10, wherein the transaction card device is a card machine or a computer terminal.

15. The system as claimed in claim 10, wherein the transaction card device is equipped with a keyboard set for inputting a special key for purchasing the transportation ticket.

16. The system as claimed in claim 10, wherein the transportation information includes a transportation company code, an origin code, a destination code, a departure date and time, a return date and time, and passenger personal information.

17. The system as claimed in claim 10, wherein the transaction card information includes personal credit reference and personal information of a card holder.

18. The system as claimed in claim 10, wherein the transportation ticket is a flight ticket, a boat ticket, a train ticket or a bus ticket.
